(19) United States
(12) Patent Application Publication
(10) Pub. No.: US 2026/0367779 A1
(43) Pub. Date: Nov. 19, 2026

(54) CONTROL DEVICE, DISPLAY SYSTEM, AND CONTROL METHOD

(71) Applicant: NEC Corporation, Tokyo (JP)

(72) Inventors: Yuki TSURUOKA, Tokyo (JP); Akihiko ONITA, Tokyo (JP); Takashi MIYAKE, Tokyo (JP); Yushi NIWA, Tokyo (JP)

(73) Assignee: NEC Corporation, Tokyo (JP)

(21) Appl. No.: 19/148,037

(22) PCT Filed: Jan. 19, 2023
(86) PCT No.: PCT/JP2023/001534

§ 371 Date: Jul. 15, 2025

(51) Int. Cl. G06F 3/0488; G02B 30/56; G06F 3/01; G06F 3/0482; G06F 3/16; G06Q 20/20; G06V 40/10; G06V 40/16

(52) U.S. Cl. CPC G06F 3/0488; G02B 30/56; G06F 3/012; G06F 3/0482; G06Q 20/20; G06V 40/11; G06V 40/161; G06F 3/016; G06F 3/167

(57) ABSTRACT

A control device includes: at least one memory storing instructions; and at least one processor configured to execute the instructions to: accept, as different operations, an operation on aerial image formation detected by a sensor included in a non-contact display and an operation on a touch panel overlaid on a part of a surface of an optical element included in the non-contact display; perform processing according to an operation on the aerial image formation in a case where the operation on the aerial image formation is accepted, and performing processing according to an operation on the touch panel in a case where the operation on the touch panel is accepted; and control display on a display included in the non-contact display based on a processing result.

### TECHNICAL FIELD

The present disclosure relates to a control device and the like.

### BACKGROUND ART

There is a non-contact display that forms a display on the display in the air (for example, PTL1 to PTL3, and the like). In the non-contact display, for example, a sensor detects an operation on aerial image formation by the user.

### CITATION LIST

### Patent Literature

PTL 1: JP 2022-93789 A
PTL 2: WO 2016/047173 A1
PTL 3: WO 2022/045294 A1

### SUMMARY OF INVENTION

### Technical Problem

In a case where a non-contact display is used, it is difficult to perform various operations.

An object of the present disclosure is to provide a control device or the like that enables various operations when a non-contact display is used.

### Solution to Problem

A control device according to one aspect of the present disclosure includes: an accepting means for accepting, as different operations, an operation on aerial image formation detected by a sensor included in a non-contact display and an operation on a touch panel overlaid on a part of a surface of an optical element included in the non-contact display; a processing means for performing processing according to an operation on the aerial image formation in a case where the operation on the aerial image formation is accepted, and performing processing according to an operation on the touch panel in a case where the operation on the touch panel is accepted; and an output control means for controlling display on a display included in the non-contact display based on a processing result by the processing means.

A display system according to one aspect of the present disclosure includes a non-contact display and a control device, in which
the non-contact display includes a touch panel, an optical element, a display, and a sensor,
the touch panel is arranged by being overlaid on a part of a surface of the optical element,
the touch panel detects an operation on a touch panel thereof,
the sensor detects an operation on the display and aerial image formation formed by the optical element, and
the control device includes an accepting means for accepting, as different operations, an operation on the aerial image formation and an operation on the touch panel, a processing means for performing processing according to an operation on the aerial image formation in a case where the operation on the aerial image formation is accepted, and performing processing according to an operation on the touch panel in a case where the operation on the touch panel is accepted, and an output control means for controlling display on the display based on a processing result by the processing means.

A control device according to one aspect of the present disclosure includes an accepting means for accepting an operation on aerial image formation detected by a sensor included in a non-contact display installed in a vehicle and an operation on a touch panel overlaid on a part of a surface of an optical element included in the non-contact display, a processing means for performing processing according to an operation on the aerial image formation in a case where the operation on the aerial image formation is accepted, and performing processing according to an operation on the touch panel in a case where the operation on the touch panel is accepted, and an output control means for controlling display on a display included in the non-contact display based on a processing result by the processing means, in which the optical element, the display, and the touch panel are installed in such a way that an operation surface of the touch panel and a surface of the optical element form an acute angle with a display surface of the display, an operation on the aerial image formation is an operation by a passenger on a passenger seat in the vehicle, an operation on the touch panel is an operation by a driver of the vehicle, and the accepting means accepts an operation on the aerial image formation and does not accept an operation on the touch panel while the vehicle is traveling.

A control method according to one aspect of the present disclosure includes accepting, as different operations, an operation on aerial image formation detected by a sensor included in a non-contact display and an operation on a touch panel overlaid on a part of a surface of an optical element included in the non-contact display, performing processing according to an operation on the aerial image formation in a case where the operation on the aerial image formation is accepted, and performing processing according to an operation on the touch panel in a case where the operation on the touch panel is accepted, and controlling display on a display included in the non-contact display based on a processing result by the processing means.

A control method according to one aspect of the present disclosure includes accepting an operation on aerial image formation detected by a sensor included in a non-contact display installed in a vehicle and an operation on a touch panel overlaid on a part of a surface of an optical element included in the non-contact display, performing processing according to an operation on the aerial image formation in a case where the operation on the aerial image formation is accepted, and performing processing according to an operation on the touch panel in a case where the operation on the touch panel is accepted, and controlling display on a display included in the non-contact display based on a processing result, in which the optical element, the display, and the touch panel are installed in such a way that an operation surface of the touch panel and a surface of the optical element form an acute angle with a display surface of the display, an operation on the aerial image formation is an operation by a passenger on a passenger seat in the vehicle, an operation on the touch panel is an operation by a driver of the vehicle, and in the accepting, an operation on the aerial image formation is accepted and an operation on the touch panel is not accepted while the vehicle is traveling.

A program according to one aspect of the present disclosure causes a computer to execute accepting, as different operations, an operation on aerial image formation detected by a sensor included in a non-contact display and an operation on a touch panel overlaid on a part of a surface of an optical element included in the non-contact display, performing processing according to an operation on the aerial image formation in a case where the operation on the aerial image formation is accepted, and performing processing according to an operation on the touch panel in a case where the operation on the touch panel is accepted, and controlling display on a display included in the non-contact display based on a processing result.

A program according to one aspect of the present disclosure causes a computer to execute accepting an operation on aerial image formation detected by a sensor included in a non-contact display installed in a vehicle and an operation on a touch panel overlaid on a part of a surface of an optical element included in the non-contact display, performing processing according to an operation on the aerial image formation in a case where the operation on the aerial image formation is accepted, and performing processing according to an operation on the touch panel in a case where the operation on the touch panel is accepted, and controlling display on a display included in the non-contact display based on a processing result, in which the optical element, the display, and the touch panel are installed in such a way that an operation surface of the touch panel and a surface of the optical element form an acute angle with a display surface of the display, an operation on the aerial image formation is an operation by a passenger on a passenger seat in the vehicle, an operation on the touch panel is an operation by a driver of the vehicle, and in the accepting, an operation on the aerial image formation is accepted and an operation on the touch panel is not accepted while the vehicle is traveling.

The program may be stored in a non-transitory computer-readable recording medium.

### Advantageous Effects of Invention

According to the present disclosure, various operations can be performed when a non-contact display is used.

### BRIEF DESCRIPTION OF DRAWINGS

FIG. 1 is an explanatory diagram illustrating an example of a display system.

FIG. 2A is an explanatory diagram (part 1) simply illustrating an aerial display.

FIG. 2B is an explanatory diagram (part 2) simply illustrating the aerial display.

FIG. 3 is an explanatory diagram illustrating a hardware configuration example of a computer.

FIG. 4 is a block diagram illustrating a configuration example of a control device according to a first example embodiment.

FIG. 5 is an explanatory diagram illustrating a first installation example of an aerial display in a case where a plurality of users use the aerial display.

FIG. 6 is an explanatory diagram illustrating a second installation example of the aerial display in a case where a plurality of users use the aerial display.

FIG. 7 is an explanatory diagram illustrating an example in which a user is imaged for correcting an operation position.

FIG. 8 is an explanatory diagram illustrating an exemplary screen for correcting a standing position.

FIG. 9 is a flowchart illustrating an operation example of the control device in a case where a plurality of users use the control device.

FIG. 10 is an explanatory diagram illustrating an installation example in a case where one user operates both the touch panel and the aerial image formation.

FIG. 11A is an explanatory diagram illustrating an example in which it is determined that the operation is an operation on aerial image formation.

FIG. 11B is an explanatory diagram illustrating an example in which it is determined that the operation is not an operation on aerial image formation.

FIG. 12 is an explanatory diagram illustrating an installation example of an imaging device for detecting a position of a hand of a user.

FIG. 13 is an explanatory diagram illustrating an example in which an aerial display is used as a POS terminal.

FIG. 14 is a flowchart illustrating an operation example of the control device in a case where a plurality of users use the control device.

FIG. 15 is an explanatory diagram illustrating an installation example of a mirror in a case where aerial image formation is superimposed and displayed on an image reflected in the mirror.

FIG. 16 is an explanatory diagram illustrating a superimposed display example.

FIG. 17 is an explanatory diagram illustrating an installation example of an imaging device for causing a display to follow a movement of a user.

FIG. 18 is an explanatory diagram illustrating an example of causing a display to follow a movement of a user.

FIG. 19 is an explanatory diagram illustrating an installation example of another display in a case where aerial image formation is superimposed and displayed on an image reflected in another display.

FIG. 20 is an explanatory diagram illustrating an installation example of an object in a case where aerial image formation is superimposed and displayed on an object.

FIG. 21 is an explanatory diagram illustrating an example of superimposing and displaying aerial image formation on an object.

FIG. 22 is a block diagram illustrating a configuration example of a control device according to a second example embodiment.

FIG. 23 is a flowchart illustrating an operation example of the control device according to the second example embodiment.

### EXAMPLE EMBODIMENT

Hereinafter, example embodiments of a control device, a display system, a control method, a program, and a non-transitory recording medium recording the program according to the present disclosure will be described in detail with reference to the drawings. The present example embodiment does not limit the disclosed technology.

In each example embodiment, an aerial display will be described as an example of the non-contact display, but an example of the non-contact display is not particularly limited.

### First Example Embodiment

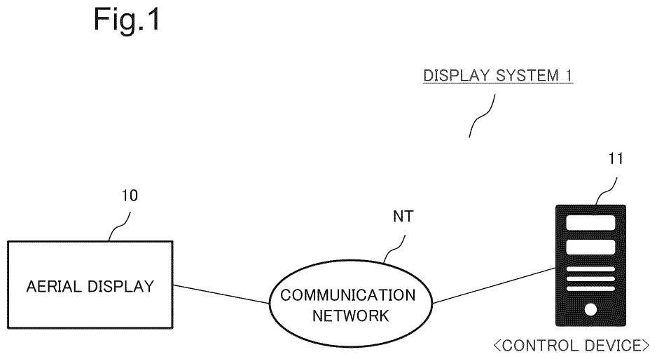

FIG. 1 is an explanatory diagram illustrating an example of a display system. A display system 1 includes an aerial display 10 and a control device 11. The control device 11 controls the aerial display 10. The control device 11 accepts a user's operation via the aerial display 10. The control device 11 displays display information on the aerial display 10.

For example, the aerial display 10 and the control device 11 are connected via a communication network NT.

The display system 1 may further include other devices. For example, the display system 1 may include an imaging device that images the user. Then, the control device 11 and the imaging device are connected via the communication network NT. For example, the communication network NT connecting the imaging device and the control device 11 and the communication network NT connecting the aerial display 10 and the control device 11 may be the same or different, and are not particularly limited.

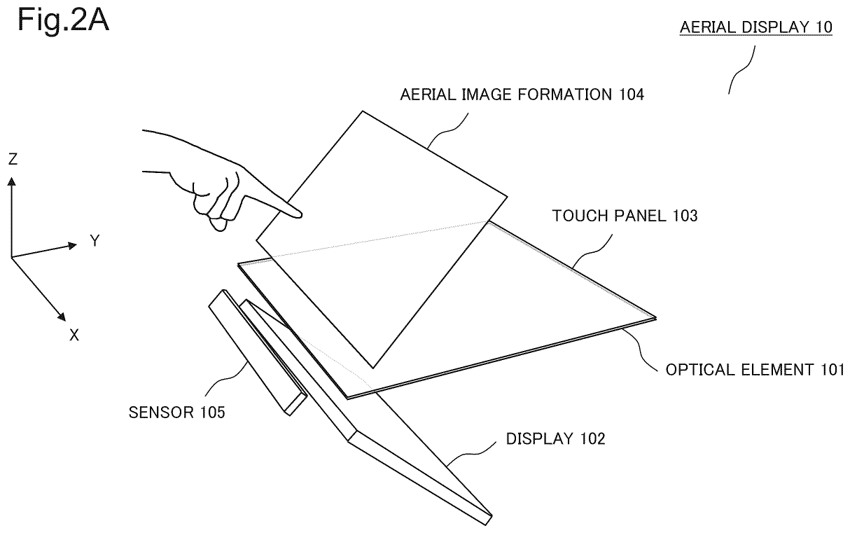

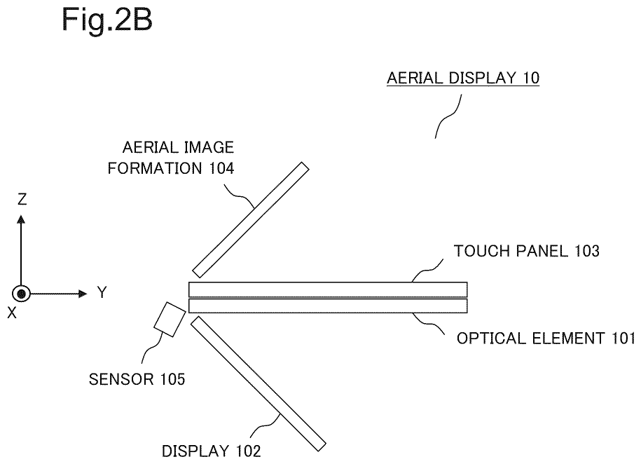

FIGS. 2A and 2B are explanatory diagrams simply illustrating the aerial display 10. In FIGS. 2A and 2B, the aerial display 10 includes, for example, an optical element 101, a display 102, a sensor 105, and a touch panel 103. In FIGS. 2A and 2B, an X axis, a Y axis, and a Z axis are defined for ease of description. In FIG. 2A, the plane of the X axis and the Y axis is, for example, substantially parallel to the surface of the optical element 101 and the operation surface of the touch panel 103. FIG. 2B illustrates the aerial display 10 when viewed from the positive direction of the X axis. The aerial display 10 has display directivity. Therefore, in a case where the user views the aerial display 10 from the positive direction of the X axis, the user cannot actually see an aerial image formation 104, but the aerial image formation 104 is illustrated for easy understanding.

In the aerial display 10, the optical element 101 transmits light rays emitted by the display of the display 102 and forms an image same as the display of the display 102 at a position opposite to that of the display 102. In FIGS. 2A and 2B, this image is the aerial image formation 104. The sensor 105 is used to operate the aerial image formation 104. The sensor 105 is, for example, a motion sensor or a three-dimensional (3D) sensor.

The angle between the display 102 and the optical element 101 may be controllable. As a result, the angle between the aerial image formation 104 and the optical element 101 is changed, and the direction of the aerial image formation 104 can be changed. Here, the display 102 may be installed such that the optical element 101 and the aerial image formation 104 are substantially parallel.

Next, the touch panel 103 is installed on at least a part of the surface of the optical element 101. For example, the operation surface of the touch panel 103 is substantially parallel to the surface of the optical element 101. Here, as an example in which the touch panel 103 is installed on the optical element 101, the touch panel 103 may be attached to at least a part of the optical element 101. In this case, the glass for protecting the optical element 101 and the touch panel 103 may be integrated. As another example, the touch panel 103 may be embedded in the optical element 101.

The aerial display 10 may include a vibration generation device that generates vibration. For example, the vibration generation device may generate vibration according to the operation under the control of the control device 11. The vibration generation device may be different between a device that generates vibration according to an operation on the aerial image formation 104 and a device that generates vibration according to an operation on the touch panel 103. The aerial display 10 may include a voice output device that outputs sound. For example, the voice output device may output a voice relevant to the operation under the control of the control device 11. The voice output device may be different between a device that outputs a voice according to an operation on the aerial image formation 104 and a device that outputs a voice according to an operation on the touch panel 103.

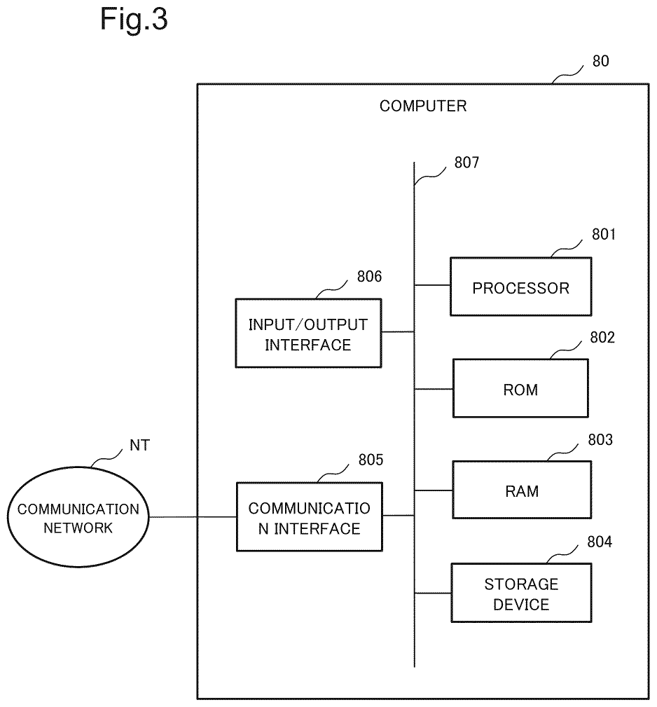

Next, a hardware configuration example in a case where the control device 11 is achieved by a computer will be described. FIG. 3 is an explanatory diagram illustrating a hardware configuration example of a computer. For example, part or all of each device can be achieved by using any combination of a computer 80 and the program as illustrated in FIG. 3.

The computer 80 includes, for example, a processor 801, a read only memory (ROM) 802, a random access memory (RAM) 803, and a storage device 804. The computer 80 includes a communication interface 805 and an input/output interface 806. The components are connected via a bus 807. The number of each component is not particularly limited, and each component is one or more.

The processor 801 controls the entire computer 80. As the processor 801, for example, a central processing unit (CPU), a digital signal processor (DSP), a graphics processing unit (GPU), a micro processing unit (MPU), a floating point number processing unit (FPU), a physics processing unit (PPU), a tensor processing unit (TPU), a quantum processor, a microcontroller, a combination thereof, or the like can be used.

The computer 80 includes the ROM 802, the RAM 803, the storage device 804, and the like as storage units. Examples of the storage device 804 include a semiconductor memory such as a flash memory, a hard disk drive (HDD), a solid state drive (SSD), and the like. For example, the storage device 804 stores an operating system (OS) program, an application program, a program according to each example embodiment, and the like. Alternatively, the ROM 802 stores an application program, a program according to each example embodiment, and the like. The RAM 803 is used as a work area of the processor 801.

The processor 801 loads a program stored in the storage device 804, the ROM 802, or the like. The processor 801 executes each process coded in the program. The processor 801 may download various programs via the communication network NT. The processor 801 functions as part or all of the computer 80. The processor 801 may execute processes or instructions in the flowchart illustrated based on the program.

The communication interface 805 is connected to the communication network NT such as a local area network (LAN) or a wide area network (WAN) through a wireless or wired communication line. The communication network NT may include a plurality of communication networks NT. As a result, the computer 80 is connected to an external device or an external computer 80 via the communication network NT. The communication interface 805 manages an interface between the communication network NT and the inside of the computer 80. The communication interface 805 controls an input/output of data from the external device or the external computer 80.

The input/output interface 806 is connected to at least any one of an input device, an output device, and an input/output device. The connection method may be wireless or wired. Examples of the input device include a keyboard, a mouse, and a microphone. Examples of the output device include a display device, a lighting device, and a voice output device that outputs a sound. Examples of the input/output device include a touch panel type of display. The input device, the output device, the input/output device, and the like may be built in the computer 80 or may be externally attached.

The hardware configuration of the computer 80 is an example. The computer 80 may have some components illustrated in FIG. 3. The computer 80 may have components other than those illustrated in FIG. 3. For example, the computer 80 may include a drive device or the like. The processor 801 may read a program or data stored in a recording medium attached to a drive device or the like into the RAM 803. Examples of the non-transitory tangible recording medium include an optical disk, a flexible disk, a magnetic optical disk, and a Universal Serial Bus (USB) memory. As described above, for example, the computer 80 may include an input device such as a keyboard and a mouse. The computer 80 may include an output device such as a display 102.

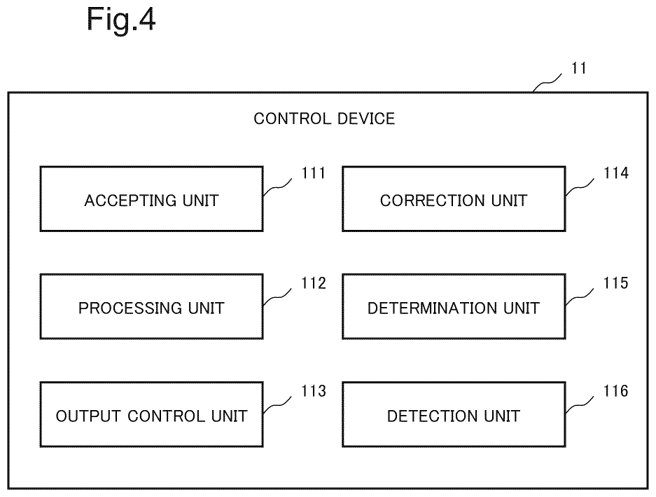

Next, each functional unit of the control device 11 will be described. FIG. 4 is a block diagram illustrating a configuration example of the control device 11 according to a first example embodiment. The control device 11 includes an accepting unit 111, a processing unit 112, an output control unit 113, a correction unit 114, a determination unit 115, and a detection unit 116.

First, the accepting unit 111 accepts an operation on the aerial image formation 104 detected by the sensor 105 and an operation on the touch panel 103. For example, the accepting unit 111 may accept the operation on the aerial image formation 104 detected by the sensor 105 and the operation on the touch panel 103 as different operations. Here, the operation on the aerial image formation 104 and the operation on the touch panel 103 are not particularly limited to be different. Taking a button operation as an example, the operation on the aerial image formation 104 and the operation on the touch panel 103 are different. Even if the same button is pressed, the processing by the processing unit 112 after the button is pressed may be changed. Taking a button operation as an example, the operation on the aerial image formation 104 and the operation on the touch panel 103 are different. There may be a button or the like that enables only one of the operations. For example, the accepting unit 111 may perform control to accept an operation on the aerial image formation 104 and an operation on the touch panel 103 as the same operation or as different operations according to the operated position. More specifically, for example, the accepting unit 111 accepts an operation on the aerial image formation 104 and an operation on the touch panel 103 in a predetermined region as the same operation, and accepts an operation on the aerial image formation 104 and an operation on the touch panel 103 in a region other than the predetermined region as different operations.

Next, when accepting the operation on the aerial image formation 104, the processing unit 112 performs processing according to the operation on the aerial image formation 104. When accepting an operation on the touch panel 103, the processing unit 112 performs processing according to the operation on the touch panel 103.

The output control unit 113 controls display on the display 102. The output control unit 113 controls display on the display 102, based on processing results by the processing unit 112.

The output control unit 113 changes the color of the position where the operation on the aerial image formation 104 is performed. The output control unit 113 changes the color of the position where the operation on the touch panel 103 is performed. For example, the output control unit 113 may change the color of the position where the operation is performed on the touch panel 103 so as to follow until the finger is separated. For example, in a case where the finger moves away, the output control unit 113 may return the color at the position where the color has been changed. The color of the position where the operation on the aerial image formation 104 is performed may be different from the color of the position where the operation on the touch panel 103 is performed. As a result, the user can determine which one of the aerial image formation 104 and the touch panel 103 is operated by the color.

The output control unit 113 may control voice output. For example, the output control unit 113 may perform control such that a sound to be output at the time of operation on the aerial image formation 104 is different from a sound to be output at the time of operation on the touch panel 103. As a result, it is possible to determine which one of the aerial image formation 104 and the touch panel 103 is operated by each user by voice.

The output control unit 113 may control generation of vibration. For example, the output control unit 113 may perform control such that vibration at the time of operation on the aerial image formation 104 is different from vibration at the time of operation on the touch panel 103. For example, aerial haptics using ultrasonic waves or the like may be used as the vibration at the time of operation on the aerial image formation 104. For example, as the vibration at the time of operation on the touch panel 103, an existing technique such as haptics of a smartphone or the like may be used. Vibration at the time of operation on the aerial image formation 104 and vibration at the time of operation on the touch panel 103 may be different to a distinguishable extent. As a result, it is possible to determine which one of the aerial image formation 104 and the touch panel 103 is operated by each user by vibration.

The number of users may be one or a plurality of users. After a case where there are a plurality of users is described as an example, a case where there is one user will be described as an example.

### Case of a Plurality of Users Operate

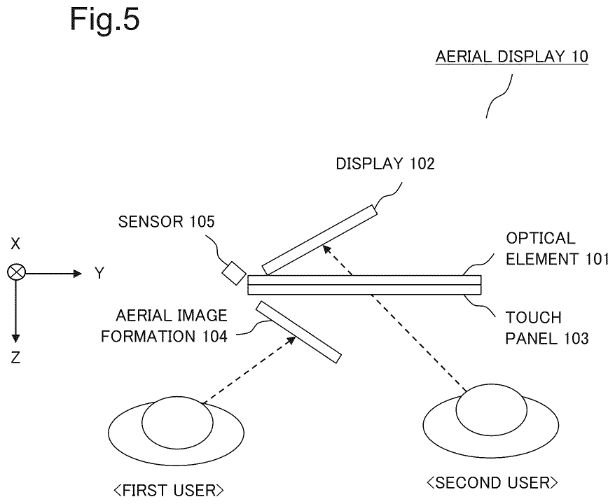

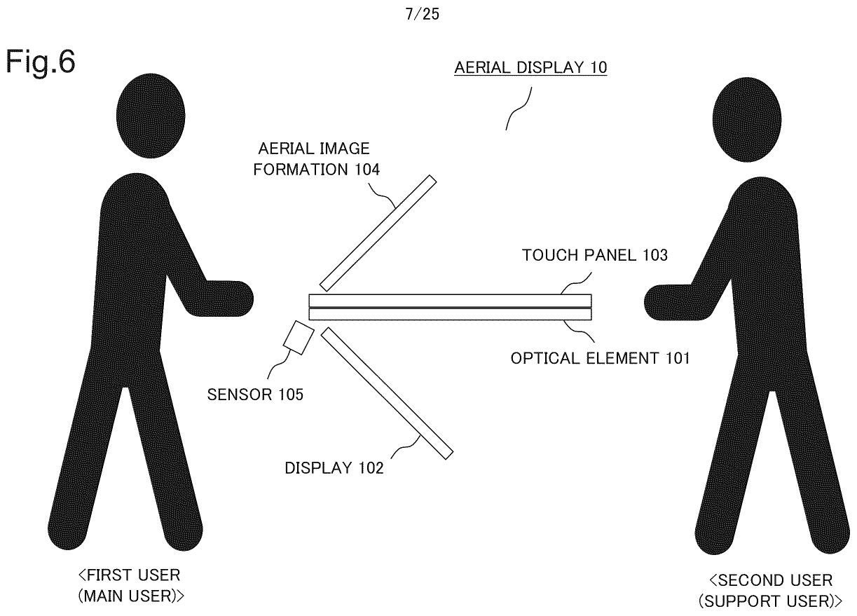

First, in a case where there are a plurality of users, an installation example of the aerial display 10 will be described with reference to FIGS. 5 and 6.

FIG. 5 is an explanatory diagram illustrating a first installation example of the aerial display 10 in a case where a plurality of users use the aerial display. In FIG. 5, for example, the surface of the optical element 101 of the aerial display 10 and the operation surface of the touch panel 103 are installed substantially parallel to a wall, a dashboard of a vehicle, or the like. FIG. 5 illustrates a state of looking at the head of the user.

As illustrated in FIG. 5, in a case where a plurality of users operate the aerial display 10 at the same timing, the display 102 is installed such that the operation surface of the touch panel 103 and the operation surface of the aerial image formation 104 are not parallel. The optical element 101, the display 102, and the touch panel 103 are installed such that the operation surface of the touch panel 103 and the surface of the optical element 101 form an acute angle with the display surface of the display 102.

In FIG. 5, a first user views the display of the display 102 via the aerial image formation 104. On the other hand, a second user directly views the display 102. By installing as illustrated in FIG. 5, the orientations of the screens seen in a case where the first user and the second user respectively see the aerial image formation 104 and the display 102 from the front are the same. However, viewing the aerial image formation 104 may appear brighter than viewing the display 102.

### Usage Example in Vehicle

For example, when installed in a vehicle or the like, the angles among the display 102 and the optical element 101 and the touch panel 103 may be decided by the position of the driver's face. The position of the driver's face may be the position of the average driver's face or the position of the individual driver's face. The position of the face of the individual driver may be detected from an image captured by an imaging device installed in the vehicle, for example. Specifically, for example, the imaging device images the face of the driver. Then, the detection unit 116 detects the position of the driver's face from the captured image. The display system 1 may decide the angle between the display 102 and the optical element 101 based on the position of the detected face, and control the position of the display 102 to be the decided angle.

The accepting unit 111 accepts an operation on the aerial image formation 104 and an operation on the touch panel 103. For example, the operation on the touch panel 103 may be an operation by a driver of the vehicle, and the operation on the aerial image formation 104 may be an operation by a passenger other than the driver. The passenger other than the driver is, for example, a passenger sitting on a passenger seat.

For example, the accepting unit 111 accepts an operation on the touch panel 103 and an operation on the aerial image formation 104 while the vehicle is not traveling. On the other hand, while the vehicle is traveling, the accepting unit 111 does not accept an operation on the touch panel 103 but accepts an operation on the aerial image formation 104. Although the vehicle is traveling as an example, in a situation that hinders safety other than traveling, the accepting unit 111 may not accept an operation on the touch panel 103 that is an operation by the driver, and may accept an operation on the aerial image formation 104 that is an operation by a passenger other than the driver. As a result, the driver and the passenger in the passenger seat can operate screens having the same contents with the touch panel 103 and the aerial image formation 104. The driver cannot operate the vehicle while the vehicle is traveling, but the passenger in the passenger seat can operate the vehicle even while the vehicle is traveling.

A general touch panel used as a display device of a car navigation device is controlled so as not to be operated during driving in order to suppress a decrease in safety. This control is performed to suppress driving operation by the driver. However, since it is difficult to determine whether the person in the passenger seat is operating or the driver is operating, there is a case where the operation of the touch panel is not collectively accepted regardless of who operates the touch panel. On the other hand, in a case where the aerial display 10 is installed in a vehicle as a display device as illustrated in FIG. 5, the driver cannot see the aerial image formation 104, and it is difficult to perform an operation on the aerial image formation 104. Therefore, by using the aerial display 10 including the touch panel 103, the person in the passenger seat can perform an operation on the aerial image formation 104 during traveling, but the driver cannot perform an operation on the touch panel 103. It is possible to perform an operation by a passenger on a passenger seat while maintaining safety while the vehicle is traveling. Therefore, various operations can be performed.

FIG. 6 is an explanatory diagram illustrating a second installation example of the aerial display 10 in a case where a plurality of users use the aerial display. For example, the aerial display 10 may be installed on a table or a wall such that the surface of the optical element 101 of the aerial display 10 and the operation surface of the touch panel 103 are substantially parallel to the plane of the table or the plane of the wall.

Similarly to FIG. 5, as illustrated in FIG. 6, in a case where a plurality of users operate the aerial display 10 at the same timing, the display 102 is installed such that the operation surface of the touch panel 103 and the operation surface of the aerial image formation 104 are not parallel.

In FIG. 6, for example, the accepting unit 111 accepts an operation on the aerial image formation 104 by the first user and an operation on the touch panel 103 by the second user. In FIG. 6, the first user may be a main user, and the second user may be a sub user. The first user may be a sub user, and the second user may be a main user.

In FIG. 6, the first user views the display of the display 102 via the aerial image formation 104. On the other hand, a second user directly views the display 102. With the installation as illustrated in FIG. 6, the second user sees the screen reversed from the screen viewed by the first user.

### Usage Example in Store

In each installation example in FIGS. 5 and 6, the aerial display 10 may be installed in a store. The aerial display 10 may be used as, for example, a display device for performing processing such as product registration, product settlement, and product search in a store.

For example, the first user who performs an operation on the aerial image formation 104 is a customer, and the second user who performs an operation on the touch panel 103 is a clerk. The customer and the clerk can view screens of the same content on the aerial image formation 104 and the display 102 directly. However, the clerk forms the aerial image formation 104 and the inverted image.

Then, for example, the accepting unit 111 accepts an operation on the aerial image formation 104 by the customer and an operation on the touch panel 103 by the clerk as different operations. For example, the operation by the customer may be an operation related to product registration, an operation related to settlement processing, or an operation related to product search. On the other hand, the operation by the clerk may be an operation for supporting the operation of the customer or an operation for performing a process dedicated to the clerk. Here, the operation on the aerial image formation 104 by the customer and the operation on the touch panel 103 by the clerk may be different from each other in that, for example, even if the same button is pressed, the processing by the processing unit 112 after the button is pressed may be changed. Alternatively, there may be a button or the like that enables only one of the operation on the aerial image formation 104 by the customer and the operation on the touch panel 103 by the clerk. For example, the screen may include a clerk button, and the accepting unit 111 may not accept a touch of the clerk button on the aerial image formation 104 as an operation, but may accept a touch of the clerk button on the touch panel 103 as an operation. Here, in a case where the operation on the touch panel 103 by the clerk is an operation for performing a process dedicated to the clerk, when the accepting unit 111 accepts a predetermined operation on the touch panel 103 by the clerk, the processing unit 112 may transition the mode from the mode of the customer to the mode of the clerk. For example, the accepting unit 111 accepts an operation on the aerial image formation 104 and accepts an operation on the touch panel 103 in the mode of the customer. On the other hand, in the clerk mode, the accepting unit 111 may accept an operation on the touch panel 103 without accepting an operation on the aerial image formation 104. More specifically, as an example of transitioning to the clerk mode, when the accepting unit 111 accepts a touch on the touch panel 103, the output control unit 113 displays a screen on which a code for a clerk can be input. Then, the accepting unit 111 may accept an input of a code for a clerk as a predetermined operation. Then, when accepting the input of the code for the clerk, the processing unit 112 may transition to the clerk mode.

The first user who operates the aerial image formation 104 may be a clerk, and the second user who operates the touch panel 103 may be a customer. When the accepting unit 111 accepts a predetermined operation on the aerial image formation 104 by the clerk, the processing unit 112 may transition the mode from the mode of the customer to the mode of the clerk. For example, in the mode of the customer, the accepting unit 111 accepts an operation on the touch panel 103 and accepts an operation on the aerial image formation 104. On the other hand, the accepting unit 111 may accept an operation on the aerial image formation 104 without accepting an operation on the touch panel 103 in the clerk mode.

### Correction Example

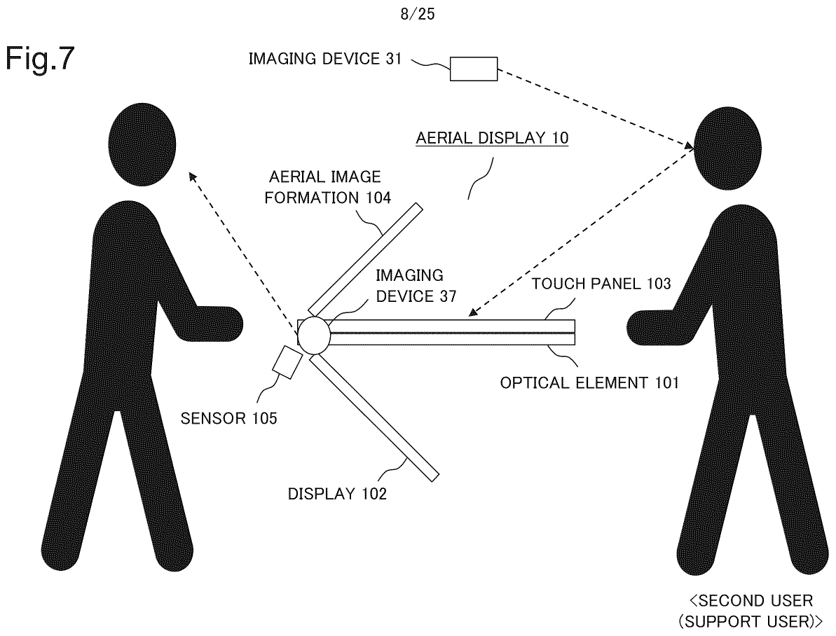

Here, there is a case where a position where the user operates the touch panel 103 and a position where the user actually wants to operate deviate from each other. There is a case where a position where the user operates the aerial image formation 104 and a position where the user actually desires to operate are shifted. Thus, the position to be operated may be corrected. A correction example of an operation position will be described with reference to FIG. 7.

FIG. 7 is an explanatory diagram illustrating an example in which a user is imaged for correcting an operation position. In FIG. 7, there is a distance between the display 102 and the touch panel 103, that is, there is a gap between the display 102 and the touch panel 103. Since the positional relationship between the display 102 and the touch panel 103 varies depending on the position of the viewpoint of the user, the operation position may be shifted in a case where the touch panel 103 performs an operation on the display on the display 102. That is, the position of the touch panel 103 relevant to the area of the display 102 that the second user is gazing at changes according to the position of the eyes of the second user. An imaging device 31 is installed so as to be able to image the second user. For example, the detection unit 116 detects the position of the face of the second user from the image of the second user captured by the imaging device 31. The correction unit 114 corrects the position of the accepted operation on the touch panel 103 based on the position of the face of the second user. Specifically, for example, the correction unit 114 calculates a correction amount between the position of the operation on the touch panel 103 and the position of the display on the display 102 based on the position of the face of the second user. When the accepting unit 111 accepts an operation on the touch panel 103, the correction unit 114 corrects the position of the accepted operation by the correction amount. Then, the processing unit 112 performs processing as an operation at the corrected position.

There is a case where a position where the user operates the aerial image formation 104 and a position where the user actually desires to operate are shifted. In a case where the position of the operation on the aerial image formation 104 is corrected, an imaging device 37 detects the position of the hand of the first user. The imaging device 37 may be, for example, a 3D camera. For example, the correction unit 114 corrects the position of the operation on the aerial image formation 104 based on the position of the hand of the first user detected by the imaging device 37. Specifically, for example, the correction unit 114 calculates a correction amount between the position of the operation on the aerial image formation 104 and the position of the display on the display 102 based on the position of the hand of the first user. When the accepting unit 111 accepts the operation on the aerial image formation 104, the correction unit 114 corrects the position of the operation on the aerial image formation 104 based on the correction amount. The processing unit 112 performs processing as an operation at the corrected position.

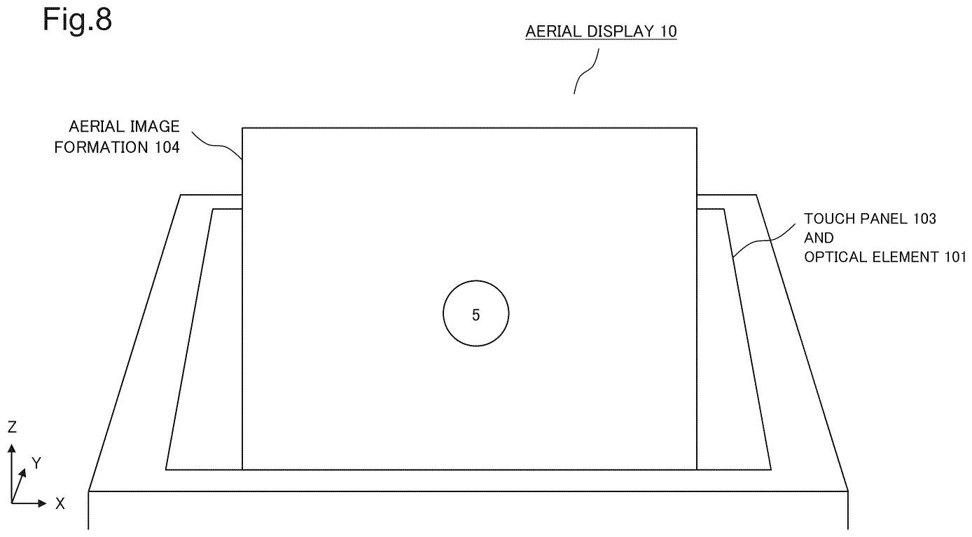

FIG. 8 is an explanatory diagram illustrating an exemplary screen for correcting the standing position. In order to correct the operation position of the aerial image formation 104, the first user may change the standing position so that the desired display can be seen. In FIG. 8, the first user is requested to change the standing position to a position where a number is put in a circle.

Similarly, for the operation on the touch panel 103, the second user may be requested to change the standing position so that the desired display can be seen.

### Flowchart

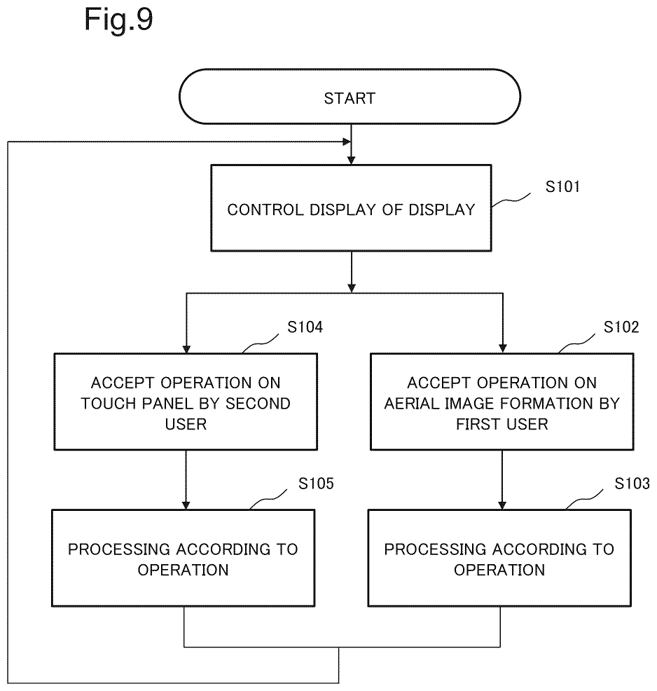

FIG. 9 is a flowchart illustrating an operation example of the control device 11 when used by a plurality of users. The output control unit 113 controls display on the display 102 (step S101). The accepting unit 111 accepts an operation on the aerial image formation 104 by the first user (step S102). The processing unit 112 performs processing according to the operation (step S103), and returns to step S101.

The accepting unit 111 accepts an operation on the touch panel 103 by the second user (step S104). The processing unit 112 performs processing according to the operation on the touch panel 103 (step S105), and returns to step S101.

The flowchart may be appropriately ended.

### Case of Operation by One User

Next, a case where one user operates both the touch panel 103 and the aerial image formation 104 will be described as an example.

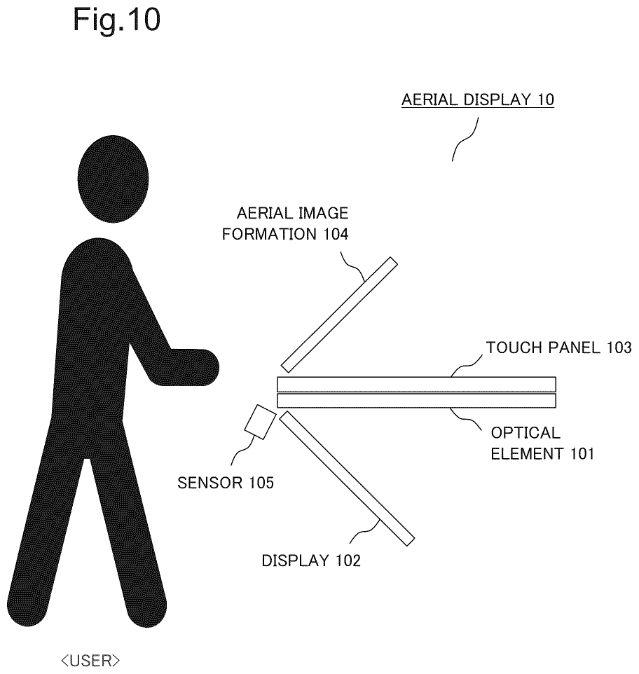

FIG. 10 is an explanatory diagram illustrating an installation example in a case where one user operates both the touch panel 103 and the aerial image formation 104. In FIG. 10, for example, the aerial display 10 is installed on a table such as a desk so that the surface of the optical element 101 of the aerial display 10 and the operation surface of the touch panel 103 are substantially parallel to the plane of the table.

In FIG. 10, the display 102 is installed such that the operation surface of the touch panel 103 and the operation surface of the aerial image formation 104 are not parallel. However, in a case where one user operates the aerial display 10, the display 102 may be installed such that the operation surface of the touch panel 103 and the operation surface of the aerial image formation 104 are substantially parallel.

The correction has been described in the example of a plurality of users, and a detailed description thereof will be omitted.

Here, for example, when one user operates the touch panel 103 and the aerial image formation 104, in a case where the user operates the touch panel 103 from a position where the aerial image formation 104 can be seen as illustrated in FIG. 10, it is necessary to pass through the aerial image formation 104 and insert a hand into the touch panel 103 side. Therefore, the determination unit 115 may determine whether the operation is for the aerial image formation 104 according to the position of the hand, for example.

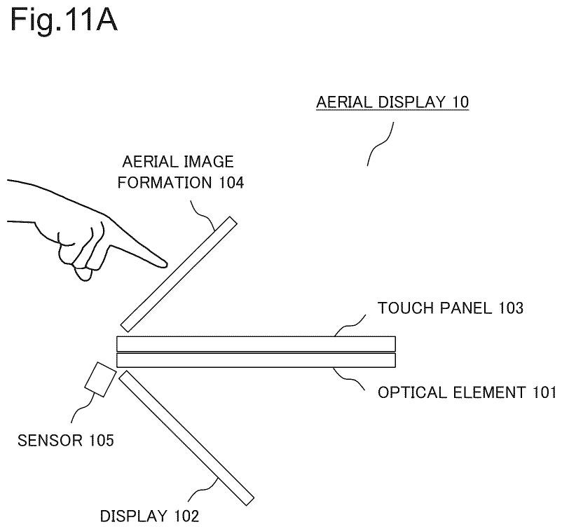

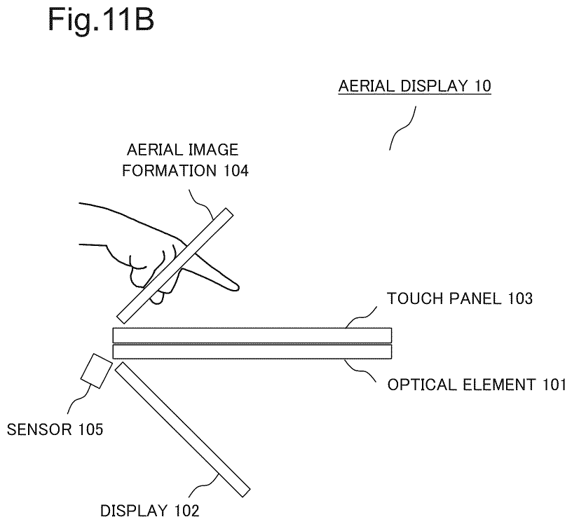

FIG. 11A is an explanatory diagram illustrating an example in which it is determined that the operation is for the aerial image formation 104. FIG. 11B is an explanatory diagram illustrating an example in which it is determined that the operation is not for the aerial image formation 104. In FIGS. 11A and 11B, for example, the sensor 105 may be a 3D sensor, and the sensor 105 may detect the position of the hand. For example, the determination unit 115 determines whether the hand of the user is present on the optical element 101 side beyond the aerial image formation 104 based on the position of the hand of the user detected by the sensor 105. As illustrated in FIG. 11A, in a case where there is no hand on the optical element 101 side, the accepting unit 111 accepts an operation on the aerial image formation 104. As illustrated in FIG. 11B, in a case where a hand is present on the optical element 101 side, the accepting unit 111 does not accept an operation on the aerial image formation 104.

Further, as illustrated in FIG. 11A, in a case where there is no hand on the optical element 101 side, the accepting unit 111 does not accept an operation on the touch panel 103. As illustrated in FIG. 11B, in a case where a hand is present on the optical element 101 side, the accepting unit 111 does not accept an operation on the aerial image formation 104. As a result, when the user performs an operation on the aerial image formation 104, it is possible to prevent an operation on the touch panel 103 by another user from being accepted.

However, in a case where a hand is present on the optical element 101 side, the accepting unit 111 may be capable of accepting an operation on the touch panel 103.

A method of detecting the position of the hand may be detected by the sensor 105 or may be detected from an image captured by the imaging device, and is not particularly limited.

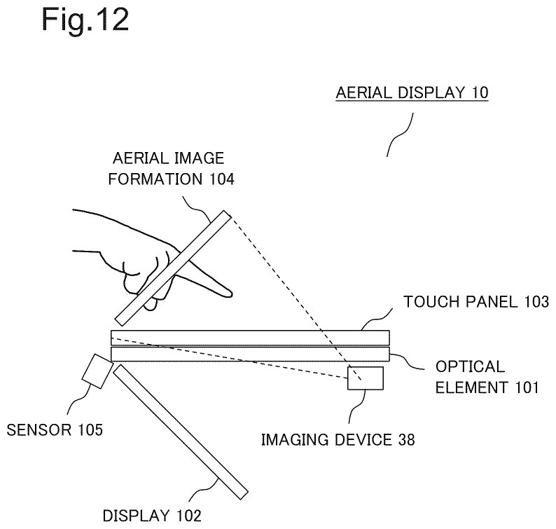

FIG. 12 is an explanatory diagram illustrating an installation example of an imaging device for detecting the position of the hand of the user. While the sensor 105 is installed at hand, for example, an imaging device 38 is installed at a position where the periphery of the aerial image formation 104 can be imaged. For example, the imaging device 38 may be an imaging device including a function capable of measuring distance information.

For example, the imaging device 38 images the hand of the user. A broken line indicates an example of a range imaged by the imaging device 38. Then, for example, the detection unit 116 detects the position of the hand of the user from the image of the user captured by the imaging device 38. The determination unit 115 determines whether the hand of the user is present on the optical element 101 side beyond the aerial image formation 104 based on the position of the hand of the user. In a case where there is no hand on the optical element 101 side, the accepting unit 111 accepts an operation on the aerial image formation 104. In a case where the hand is on the optical element 101 side, the accepting unit 111 does not accept an operation on the aerial image formation 104.

Although the example in which the position of the hand is detected has been described, the position of the finger may be detected in more detail. For example, the determination unit 115 determines whether the finger of the user is present on the optical element 101 side beyond the aerial image formation 104 based on the detected position of the finger of the user. In a case where there is no finger on the optical element 101 side, the accepting unit 111 accepts an operation on the aerial image formation 104. In a case where the finger is on the optical element 101 side, the accepting unit 111 does not accept an operation on the aerial image formation 104.

### Example of Different Operation

Here, an example in which one user performs a plurality of different operations when using the aerial display 10 will be described. The examples described below may be similarly used in the case of a plurality of users.

For example, an input device such as a mouse can make a plurality of transitions from one mouse cursor. As described above, in the case of the operation on the aerial image formation 104, it is difficult to perform various operations. Therefore, various operations can be intuitively performed by performing different operations between the operation on the aerial image formation 104 and the operation on the touch panel 103.

For example, a left click operation of the mouse and a right click operation of the mouse may be achieved by an operation on the aerial image formation 104 and an operation on the touch panel 103. The operation on the aerial image formation 104 may be relevant to a left click operation on the mouse. For example, the operation on the aerial image formation 104 is an operation relevant to a designated position of the aerial image formation 104. On the other hand, the operation on the touch panel 103 may be relevant to the right click operation on the mouse. For example, the operation on the touch panel 103 may be at least one of an operation for instructing display of a menu for performing an operation related to the position where the operation on the touch panel 103 has been performed, an operation for instructing display of a menu for performing a setting related to the position where the operation on the touch panel 103 has been performed, and an operation for instructing display of information related to the position where the operation on the touch panel 103 has been performed.

For example, the general-purpose operation and the detailed operation may be achieved by an operation on the aerial image formation 104 and an operation on the touch panel 103. The general-purpose operation is, for example, a common operation for any user, and the detailed operation may be an operation in which a target differs depending on the user. For example, since the operation on the touch panel 103 has higher operability than the operation on the aerial image formation 104, the operation on the aerial image formation 104 may be a general-purpose operation, and the operation on the touch panel 103 may be a detailed operation. For example, the general-purpose operation may be a selection operation by a user's touch, and the detailed operation may be an operation of writing a character using a finger or a pen. More specifically, for example, the detailed operation is an operation of writing a character such as a sign.

For example, a normal operation and a special operation may be achieved by an operation on the aerial image formation 104 and an operation on the touch panel 103. For example, since the operation on the touch panel 103 has higher operability than the operation on the aerial image formation 104, the operation on the aerial image formation 104 may be a normal operation, and the operation on the touch panel 103 may be a special operation. Taking product registration in a store as an example, for example, the normal operation is an operation of product registration, and the special operation is an operation of canceling a product registered at the time of product registration.

For example, an important operation and an unimportant operation may be achieved by an operation on the aerial image formation 104 and an operation on the touch panel 103. Since the operation on the touch panel 103 has higher operability than the operation on the aerial image formation 104, the operation on the aerial image formation 104 may be an unimportant operation, and the operation on the touch panel 103 may be an important operation. Taking product registration and settlement at a store as an example, an operation of product registration, an operation of selecting a settlement method, and the like can be easily canceled, and cannot be said to be an important operation. On the other hand, since an operation leading to payment, such as an operation instructing execution of payment, cannot be easily canceled and money delivery occurs, it can be said that the operation is an important operation.

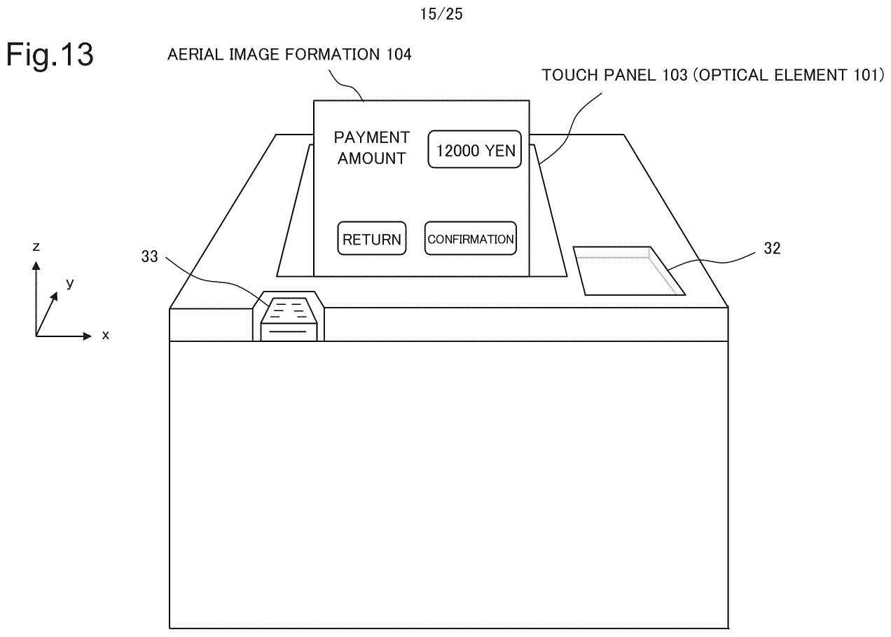

FIG. 13 is an explanatory diagram illustrating an example in which the aerial display 10 is used as a point of sales (POS) terminal. In a retail store such as a convenience store, a non-contact display may be used to register a product or settle up a product. FIG. 13 illustrates an example in which the aerial display 10 illustrated in FIGS. 2A and 2B is also used as a self-POS terminal operable by a customer. For example, FIG. 13 illustrates a reading device 32 that reads a barcode, a reading device 33 that reads a credit card, and the like together with the aerial display 10.

For example, in FIG. 13, a confirmation button for confirming payment and a return button for returning to the processing before payment are displayed in the aerial image formation 104. For example, the return button can be operated by an operation on the aerial image formation 104, and the confirmation button can be operated by an operation on the touch panel 103.

For example, in the case of use in a store, an operation related to a product may be an operation on the touch panel 103, and an operation related to shopping other than a product may be an operation on the aerial image formation 104. The operation related to the product may be, for example, an operation for performing product registration. For example, the operation for performing the product registration may be a decision operation for registering the product for which the product code has been read in the product purchase list, or may be an operation for inputting the quantity of products for which the product code has been acquired, and is not particularly limited. In a case where a package is shipped, an operation such as decision of shipment may be an operation on the touch panel 103, and an operation other than shipment may be an operation on the aerial image formation 104. The operation other than shipment may be, for example, an input operation of a destination or an address of a delivery destination.

### Flowchart

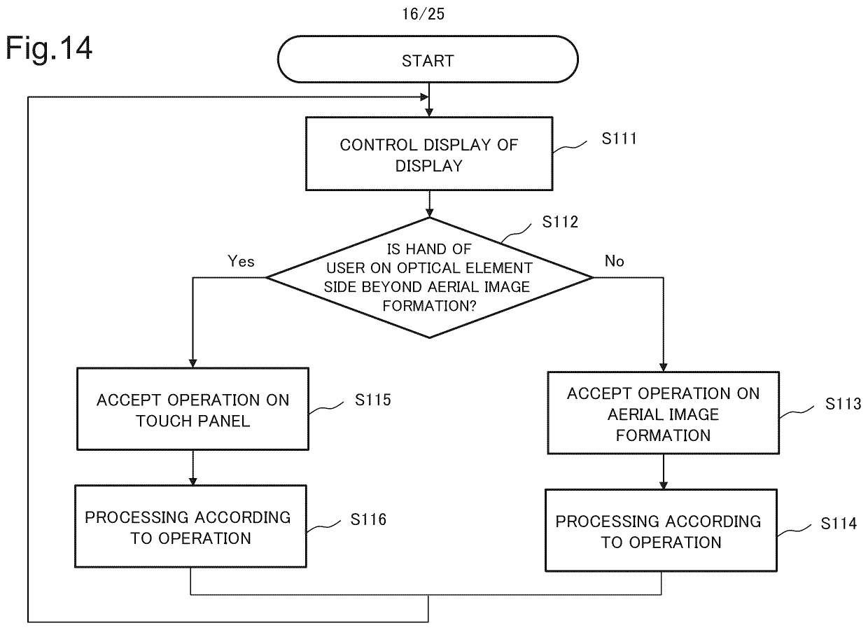

FIG. 14 is a flowchart illustrating an operation example of the control device 11 when used by a plurality of users. The output control unit 113 controls display on the display 102 (step S111). The determination unit 115 determines whether the hand of the user is present on the optical element 101 side beyond the aerial image formation 104 based on the position of the hand of the user (step S112).

In a case where the hand of the user exceeds the aerial image formation 104 and is not on the optical element 101 side (step S112: No), the accepting unit 111 accepts an operation on the aerial image formation 104 (step S113). Then, the processing unit 112 performs processing according to the operation on the aerial image formation 104 (step S114), and returns to step S111.

In a case where the hand of the user is present on the optical element 101 side beyond the aerial image formation 104 (step S112: Yes), the accepting unit 111 accepts an operation on the touch panel 103 (step S115). Here, in a case where the hand of the user is present on the optical element 101 side beyond the aerial image formation 104, the accepting unit 111 does not accept an operation on the aerial image formation 104. Then, the processing unit 112 performs processing according to the operation on the touch panel 103 (step S116), and returns to step S111.

The flowchart may be appropriately ended. The determination unit 115 may also perform a process of determining whether the hand of the user is present on the optical element 101 side beyond the aerial image formation 104 in a case where a plurality of users operate the process.

For example, the determination unit 115 may determine whether the hand of the first user is present on the optical element 101 side beyond the aerial image formation 104. Then, in a case where the hand of the first user is present on the optical element 101 side beyond the aerial image formation 104, the accepting unit 111 does not accept the operation on the aerial image formation 104.

### Example of Superimposing and Displaying Aerial Image Formation 104

As an application example using the aerial display 10, an example in which the aerial image formation 104 is superimposed and displayed on an image reflected in a mirror, an actual object or organism, or another display 102 will be described.

### Example of Superimposing and Displaying Aerial Image Formation 104 on Image Reflected in Mirror

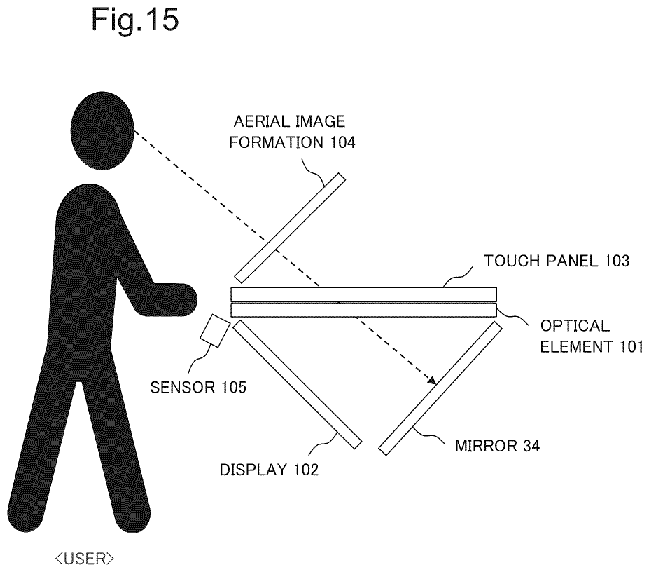

FIG. 15 is an explanatory diagram illustrating an installation example of a mirror in a case where the aerial image formation 104 is superimposed and displayed on an image reflected in the mirror. For example, the display system 1 further includes a mirror 34. The mirror 34 is arranged on a surface opposite to the aerial image formation 104 with respect to the optical element 101 such that the image reflected in the mirror 34 and the aerial image formation 104 by the aerial display 10 are superimposed. That is, the mirror 34 is arranged to face the aerial image formation 104 with respect to the optical element 101 included in the aerial display 10. As a result, the user can view the mirror 34 on the extension in which the aerial image formation 104 can be visually recognized. Therefore, the user views the image in which the user appears in the mirror 34 and the aerial image formation 104 as being superimposed.

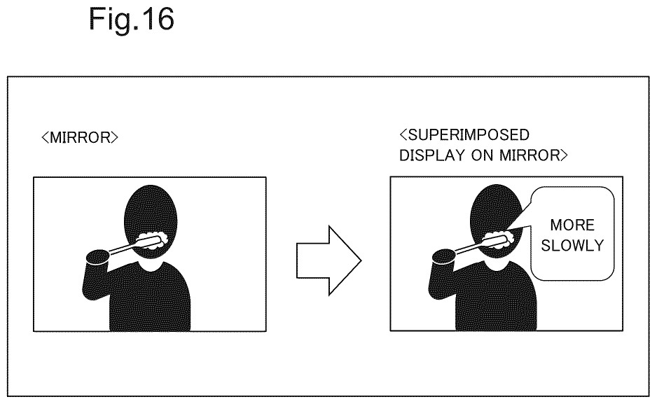

FIG. 16 is an explanatory diagram illustrating a superimposed display example. For example, the user is reflected in the mirror 34. A comment such as “more slowly” is displayed on the aerial image formation 104. As a result, the comment is superimposed and displayed on the user reflected in the mirror 34.

In this manner, the aerial display 10 can be used to display graphics such as characters and pictures superimposed on an image reflected in the mirror 34 like a smart mirror.

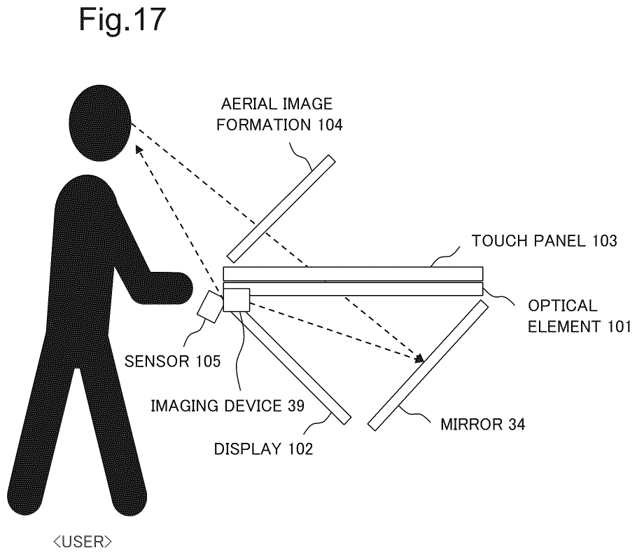

FIG. 17 is an explanatory diagram illustrating an installation example of the imaging device for causing the display to follow the movement of the user. In FIG. 17, the display system 1 may further include an imaging device 39. The imaging device 39 is installed in the optical element 101 included in the aerial display 10, and images the user reflected in the mirror 34 or the user. The detection unit 116 detects the movement of the user from the image captured by the imaging device 39. Then, the output control unit 113 decides the display of the display 102 of the aerial display 10 based on the movement of the user.

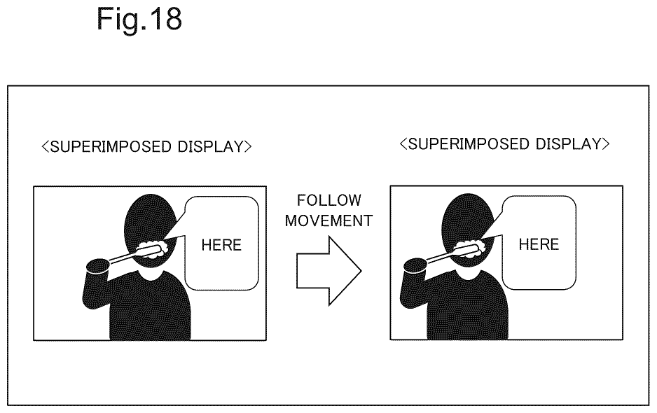

FIG. 18 is an explanatory diagram illustrating an example of causing the display to follow the movement of the user. In FIG. 18, a user is reflected in the mirror 34. Then, a comment “Here” is displayed on the aerial image formation 104. The imaging device 39 images the user. Here, when the user moves, the detection unit 116 detects the movement of the user from the image captured by the imaging device 39. Then, based on the movement of the user, the output control unit 113 controls the display of the display 102 of the aerial display 10 so that the position of the comment “Here” to be displayed on the aerial image formation 104 follows the movement of the user.

Here, for example, an example in which the operation on the touch panel 103 and the operation on the aerial image formation 104 is distinguished in a case where the aerial image formation 104 is superimposed and displayed on the image reflected in the mirror 34 will be described. For example, in a case where the user desires to designate his/her face reflected in the mirror 34, the operation to designate the face may be an operation on the touch panel 103, and another general operation may be an operation on the aerial image formation 104.

As a use example when the aerial image formation 104 is superimposed and displayed on the image reflected in the mirror 34, it can be used when instruction or practice is performed such as tooth brushing instruction, makeup instruction, exercise instruction, and work instruction to a clerk.

The difference from the smart mirror is that the aerial image formation 104 and the image reflected in the mirror 34 to be superimposed on the aerial image formation 104 are separated from each other. A difference from the smart mirror is that the imaging device 39 that images the user can be fixedly arranged.

### Example of Superimposing and Displaying Aerial Image Formation 104 on Image Reflected on Another Display 102

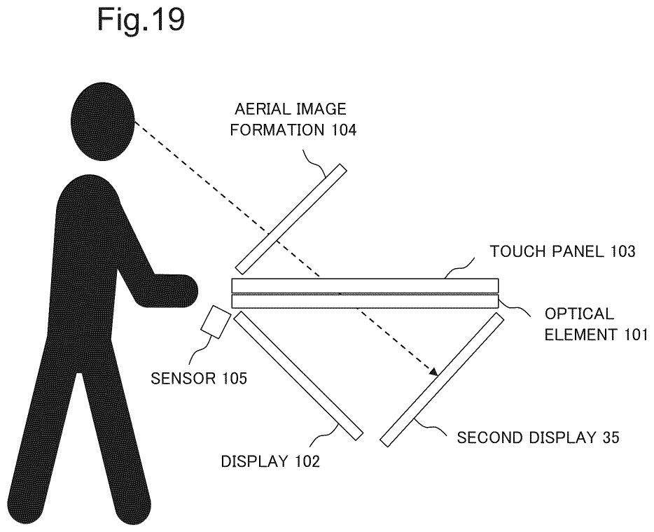

FIG. 19 is an explanatory diagram illustrating an installation example of another display 102 in a case where the aerial image formation 104 is superimposed and displayed on an image appearing on another display 102. The display system 1 further includes a second display 35. For example, the second display 35 is arranged on a surface opposite to the aerial image formation 104 with respect to the optical element 101 such that the display of the second display 35 and the aerial image formation 104 by the aerial display 10 are superimposed. That is, the second display 35 is arranged to face the aerial image formation 104 with respect to the optical element 101 included in the aerial display 10. As a result, the user can view the screen of the second display 35 on the extension where the aerial image formation 104 can be visually recognized. Therefore, the aerial image formation 104 is superimposed and displayed on the image displayed on the second display 35.

The output control unit 113 may control display on the second display 35, for example.

### Example of Superimposing and Displaying Aerial Image Formation 104 on Actual Object

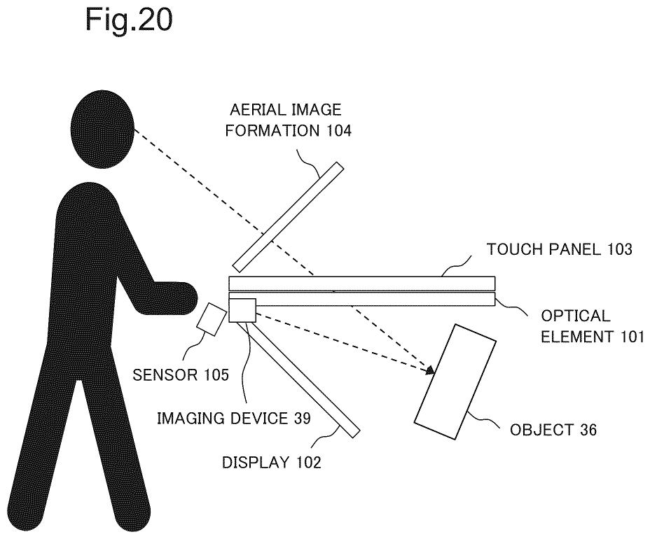

FIG. 20 is an explanatory diagram illustrating an installation example of an object in a case where the aerial image formation 104 is superimposed and displayed on the object. The display system 1 further includes an object 36. The object 36 is arranged to face the aerial image formation 104 with respect to the optical element 101 included in the aerial display 10 on an extension where the aerial image formation 104 can be visually recognized so that the object 36 and the aerial image formation 104 by the aerial display 10 are superimposed.

The display system 1 further includes an imaging device 39 capable of an imaging object 36. For example, the imaging device 39 images the object 36. The detection unit 116 detects the object 36 from the captured image. Then, the processing unit 112 may decide the display content of the display 102 based on the detected object 36. The output control unit 113 displays the decided display content on the display 102.

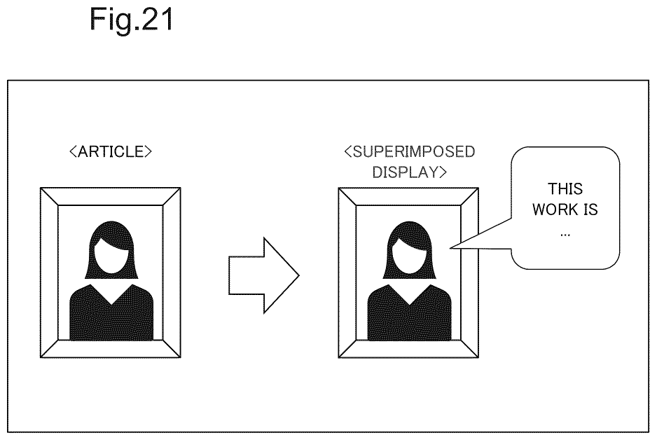

FIG. 21 is an explanatory diagram illustrating an example in which the aerial image formation 104 is superimposed and displayed on the object 36. In FIG. 21, a painting will be described as an example of the object 36. The imaging device 39 captures an image of a painting. The output control unit 113 detects a painting from the captured image. The processing unit 112 may decide the display content of the display 102 based on the detected object 36. For example, the output control unit 113 displays the decided display content on the display 102. Specifically, for example, the output control unit 113 may display the description of the painting on the display 102. This causes the description of the painting to be superimposed on the painting.

The object is not limited to the object 36, and may be a plant, an organism, or the like. The installation examples in FIGS. 15, 19, and 20 are examples. For example, an image or an actual object 36 on the floor may be superimposed and displayed from the ceiling using the aerial display 10.

As described above, in the first example embodiment, the display system 1 accepts an operation on the aerial image formation 104 and an operation on the touch panel 103 overlaid on a part of the surface of the optical element 101 as different operations. As a result, various operations can be performed using the aerial display 10.

For example, the operation on the aerial image formation 104 is an operation by the first user, and the operation on the touch panel 103 is an operation by the second user. In this manner, a plurality of users can simultaneously perform different operations on the aerial display 10.

There is a gap between the display 102 and the touch panel 103. Therefore, the display system 1 corrects the positional relationship between the display on the display 102 and the touch panel 103. As a result, it is possible to more accurately recognize the operation desired by the user.

In a case where the aerial display 10 is used as a display device of a car navigation device, if the operation by the driver is an operation on the touch panel 103 and the passenger on the passenger seat is an operation on the aerial image formation 104, the display system 1 accepts the operation on the aerial image formation 104 and does not accept the operation on the touch panel 103 while the vehicle is traveling. As a result, the passenger in the passenger seat can operate the aerial display 10 while ensuring safety by the driver.

The aerial display 10 may be used as a display device in a store. In such a case, the operation on the touch panel 103 may be an operation by a clerk, and the operation on the aerial image formation 104 may be an operation by a customer. For example, a clerk can support a customer's operation while the customer is operating.

The display system 1 may output different sounds at the time of operation on the aerial image formation 104 and at the time of operation on the touch panel 103.

The display system 1 outputs different vibrations at the time of operation on the aerial image formation 104 and at the time of operation on the touch panel 103.

The operation of the mouse may be achieved by an operation using the touch panel 103 and an operation using the aerial image formation 104. For example, the operation on the aerial image formation 104 is an operation relevant to a designated position of the aerial image formation 104. For example, the operation on the touch panel 103 is at least one of an operation for instructing display of a menu for performing an operation related to the position where the operation on the touch panel 103 has been performed, an operation for instructing display of a menu for performing a setting related to the position where the operation on the touch panel 103 has been performed, and an operation for instructing display of information related to the position where the operation on the touch panel 103 has been performed.

In a case where the aerial display 10 is installed as a display device in a store, for example, the operation on the touch panel 103 may be an operation related to payment among operations related to product registration and settlement, and the operation on the aerial image formation 104 may be an operation other than the operation related to payment among the operations related to product registration and settlement.

The display system 1 determines whether the hand of the user is present on the optical element 101 side beyond the aerial image formation 104 based on the position of the hand of the user who performs the operation on the aerial image formation 104. The method of detecting the position of the hand may be detected by the sensor 105 that detects an operation on the aerial image formation 104, or the position of the hand may be detected from an image captured by the imaging device 38 that images the hand of the user who performs the operation on the aerial image formation 104. Then, the display system 1 accepts an operation with respect to the aerial image formation 104 in a case where the hand is not on the optical element 101 side, and does not accept an operation with respect to the aerial image formation 104 in a case where the hand is on the optical element 101 side. As a result, it is possible to distinguish between the operation on the aerial image formation 104 and the operation on the touch panel 103.

The display system 1 detects the position of the face of the user from the image in which the user performing the operation on the aerial image formation 104 is imaged by the imaging device 37. The display system 1 corrects the positional relationship between the operation on the aerial image formation 104 and the operation on the touch panel 103 based on the detected position of the face of the user.

### Second Example Embodiment

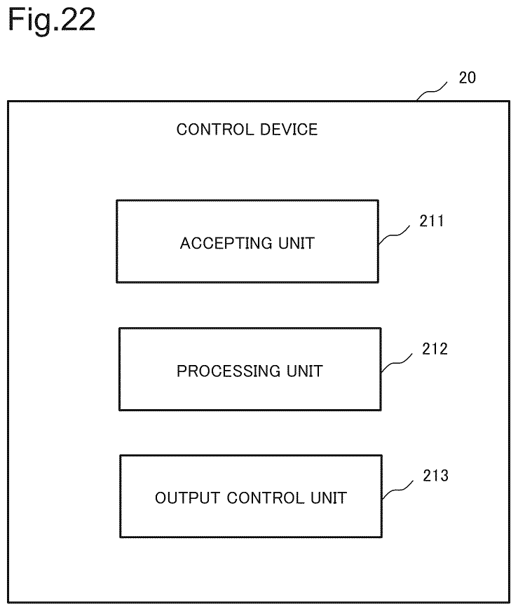

Next, an example of basic functions of a control device according to a second example embodiment will be described with reference to the drawings. FIG. 22 is a block diagram illustrating a configuration example of a control device according to the second example embodiment. A control device 21 includes an accepting unit 211, a processing unit 212, and an output control unit 213. The accepting unit 211 may be a basic function of the accepting unit 111 in the first example embodiment. The processing unit 212 may be a basic function of the processing unit 112 in the first example embodiment. The output control unit 213 may be a basic function of the output control unit 113 in the first example embodiment.

The accepting unit 211 accepts an operation on aerial image formation detected by a sensor included in the non-contact display and an operation on a touch panel overlaid on a part of a surface of an optical element included in the non-contact display as different operations.

The processing unit 212, upon accepting an operation performed with respect to the aerial image, performs processing in accordance with an operation performed with respect to the aerial image, and upon accepting an operation performed with respect to the touch panel, performs processing in accordance with an operation performed with respect to the touch panel.

The output control unit 213 controls display on a display included in the non-contact display based on a processing result by the processing unit 212.

### Flowchart

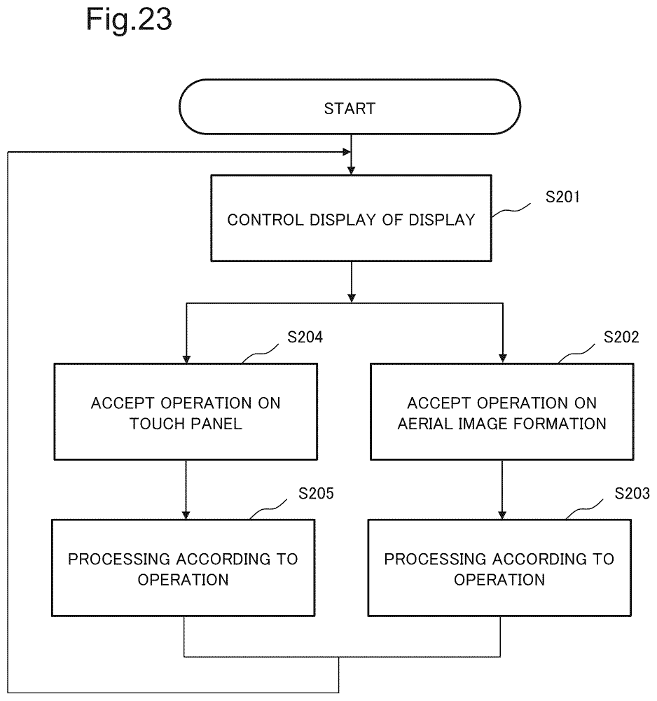

FIG. 23 is a flowchart illustrating an operation example of the control device 21 according to the second example embodiment. The output control unit 213 controls display on the display (step S201). The accepting unit 211 accepts an operation on aerial image formation (step S202). The processing unit 212 performs processing according to the operation (step S203), and returns to step S201, and the output control unit 213 performs processing according to the operation based on the processing result by the processing unit 212.

The accepting unit 211 accepts an operation on the touch panel (step S204). The processing unit 212 performs processing according to the operation on the touch panel (step S205), and returns to step S201, and the output control unit 213 performs processing according to the operation based on the processing result by the processing unit 212.

The flowchart may be appropriately ended.

As described above, in the second example embodiment, the control device 21 accepts the operation on the aerial image formation and the operation on the touch panel as different operations, and performs processing according to each operation. This makes it possible to perform various operations when using the non-contact display.

In the second example embodiment, a hardware configuration in a case where the control device 21 is implemented by a computer may be the same as a hardware configuration in a case where the control device 21 described in the first example embodiment is implemented by a computer, and a detailed description thereof will be omitted.

The description of each example embodiment is ended. Each example embodiment may be modified. The example embodiments may be used in combination as appropriate.

In each example embodiment, the display system 1 may include each functional unit and part of information. The control devices 11 and 21 may include each functional unit and a part of information. For example, the control device 11 may include an accepting unit 111, a processing unit 112, an output control unit 113, a correction unit 114, and a determination unit 115. For example, the control device 11 may include an accepting unit 111, a processing unit 112, an output control unit 113, and a determination unit 115. For example, the control device 11 may include an accepting unit 111, a processing unit 112, an output control unit 113, a determination unit 115, and a detection unit 116.

The example embodiments are not limited to the examples described above, and various modifications can be made. The configuration of the display system 1 and the configurations of the control devices 11 and 21 according to the example embodiment are not particularly limited. For example, the control devices 11 and 21 may be implemented by devices different for each function or data. For example, each functional unit of the control devices 11 and 21 may include a plurality of servers and implemented as a control system. For example, each functional unit of the control devices 11 and 21 may be achieved by a database server including each database (DB) and a server including each functional unit.

Each screen is an example, and is not particularly limited. In each screen, a button, a list, a checkbox, an information display field, an input field, and the like (not illustrated) may be added. The background color of the screen and the like may be changed.

The processing of generating information and the like to be displayed on the display included in the aerial display 10 may be performed by the output control unit. This processing may be performed by a display included in the aerial display 10.

There are various modifications in a method of implementing each device such as the control devices 11 and 21. For example, each device may be achieved by any combination of a computer and a program different for each component. A plurality of components included in each device may be achieved by any combination of one computer and a program.

Part or all of each component of each device may be achieved by an application specific circuit. Part or all of each component of each device may be achieved by a general-purpose circuit including a processor such as a field programmable gate array (FPGA). Part or all of each component of each device may be achieved by a combination of an application specific circuit, a general-purpose circuit, and the like. The circuit may be a single integrated circuit. Alternatively, the circuit may be divided into a plurality of integrated circuits. The plurality of integrated circuits may be configured by being connected via a bus or the like.

In a case where part or all of each component of each device is achieved by a plurality of computers, circuits, and the like, the plurality of computers, circuits, and the like may be arranged in a centralized manner or in a distributed manner.

The control method described in each example embodiment is implemented by the control device executing the control method. For example, the control method is implemented by a computer such as a server or a terminal device executing a program prepared in advance.

The program described in each example embodiment is recorded in a computer-readable recording medium such as an HDD, an SSD, a flexible disk, an optical disk, a magnetic optical disk, and a USB memory. The program is executed by being read from the recording medium by the computer. The program may be distributed via the communication network NT.

Each component of the display system and the control device in each example embodiment described above may be achieved by dedicated hardware such as a computer. Alternatively, each component may be achieved by software. Alternatively, each component may be achieved by a combination of hardware and software.

While the present disclosure has been particularly shown and described with reference to each of example embodiments, the present disclosure is not limited to the above example embodiments. The configurations and details of the present disclosure may include example embodiments to which various changes that can be grasped by those of ordinary skill in the art without departing from the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

Some or all of the above example embodiments can also be described as the following Supplementary Notes. However, some or all of the above example embodiments are not limited to the following.

### Supplementary Note 1

A control device including:
an accepting means for accepting, as different operations, an operation on aerial image formation detected by a sensor included in a non-contact display and an operation on a touch panel overlaid on a part of a surface of an optical element included in the non-contact display;
a processing means for performing processing according to an operation on the aerial image formation in a case where the operation on the aerial image formation is accepted, and performing processing according to an operation on the touch panel in a case where the operation on the touch panel is accepted; and
an output control means for controlling display on a display included in the non-contact display based on a processing result by the processing means.

### Supplementary Note 2

The control device according to Supplementary Note 1, in which
an operation on the aerial image formation is an operation by a first user, and
an operation on the touch panel is an operation by a second user.

### Supplementary Note 3

The control device according to Supplementary Note 2, including:
a detection means for detecting a position of a face of the second user from an image in which the second user is captured by an imaging device; and
a correction means for correcting a position of an accepted operation on the touch panel based on the position of the face of the second user.

### Supplementary Note 4

The control device according to Supplementary Note 2 or 3, in which
in a case where the non-contact display is installed in a vehicle,
the first user is a passenger in a passenger seat in the vehicle,
the second user is a driver of the vehicle, and
the accepting means accepts an operation on the aerial image formation and does not accept an operation on the touch panel while the vehicle is traveling.

### Supplementary Note 5

The control device according to Supplementary Note 2 or 3, in which
in a case where the non-contact display is installed in a store,
the first user is a customer, and
the second user is a clerk.

### Supplementary Note 6

The control device according to any one of Supplementary Notes 1 to 5, in which
the output control means outputs different voices at a time of operation on the aerial image formation and at a time of operation on the touch panel.

### Supplementary Note 7

The control device according to any one of Supplementary Notes 1 to 6, in which
the output control means outputs different vibrations at a time of operation on the aerial image formation and at a time of operation on the touch panel.

### Supplementary Note 8

The control device according to any one of Supplementary Notes 1 to 7, in which
an operation on the aerial image formation is an operation relevant to a designated position of the aerial image formation, and
an operation on the touch panel is at least one of an operation of instructing display of a menu for performing an operation related to a position where an operation on the touch panel has been performed, an operation of instructing display of a menu for performing a setting related to the position where an operation on the touch panel has been performed, and an operation of instructing display of information related to the position where an operation on the touch panel has been performed.

### Supplementary Note 9

The control device according to any one of Supplementary Notes 1 to 8, in which
in a case where the non-contact display is installed in a store,
an operation on the touch panel is an operation related to payment among operations related to product registration and settlement in the store, and
an operation on the aerial image formation is an operation other than an operation related to the payment among operations related to the product registration and the settlement.

### Supplementary Note 10

The control device according to any one of Supplementary Notes 1 to 9, including
a determination means for determining, based on a position of a hand of a user performing an operation on the aerial image formation, whether the hand of the user is present on an optical element side beyond the aerial image formation, in which
the accepting means accepts an operation on the aerial image formation in a case where the hand is not on the optical element side, and does not accept an operation on the aerial image formation in a case where the hand is on the optical element side.

### Supplementary Note 11

The control device according to Supplementary Note 10, in which
the determination means determines whether the hand of the user is present on the optical element side beyond the aerial image formation based on the position of the hand of the user detected by the sensor.

### Supplementary Note 12

The control device according to Supplementary Note 10, including
a detection means for detecting the hand of the user from an image in which the hand of the user performing an operation on the aerial image formation is captured by an imaging device, in which
the determination means determines whether the hand of the user is present on the optical element side beyond the aerial image formation based on the position of the detected hand of the user.

### Supplementary Note 13

The control device according to any one of Supplementary Notes 1 to 12, including:
a detection means for detecting a position of a face of a user who performs an operation on the aerial image formation from an image in which the user is captured by an imaging device; and
a correction means for correcting a position of an accepted operation on the aerial image formation based on the detected position of the face of the user.

### Supplementary Note 14

A display system including:
a non-contact display; and
a control device, in which
the non-contact display includes:
a touch panel;
an optical element;
a display; and
a sensor,
the touch panel is arranged by being overlaid on a part of a surface of the optical element,
the touch panel detects an operation on a touch panel thereof,
the sensor detects an operation on the display and aerial image formation formed by the optical element, and
the control device includes:
an accepting means for accepting, as different operations, an operation on the aerial image formation and an operation on the touch panel;
a processing means for performing processing according to an operation on the aerial image formation in a case where the operation on the aerial image formation is accepted, and performing processing according to an operation on the touch panel in a case where the operation on the touch panel is accepted; and
an output control means for controlling display on the display based on a processing result by the processing means.

### Supplementary Note 15

The display system according to Supplementary Note 14, including
a determination means for determining, based on a position of a hand of a user performing an operation on the aerial image formation, whether the hand of the user is present on the optical element side beyond the aerial image formation, in which
the accepting means accepts an operation on the aerial image formation in a case where the hand is not on the optical element side, and does not accept an operation on the aerial image formation in a case where the hand is on the optical element side.

### Supplementary Note 16

The display system according to Supplementary Note 14 or 15, further including a mirror, in which
the mirror is arranged on a surface opposite to the aerial image formation with respect to the optical element in such a way that an image reflected in the mirror and the aerial image formation are superimposed.

### Supplementary Note 17

The display system according to Supplementary Note 16, further including an imaging device, in which
the imaging device captures an image of a user who performs an operation on the aerial image formation,
the control device includes:
a detection means for detecting a movement of the user from the image captured by the imaging device, and
the output control means controls display of the display based on the movement of the user.

### Supplementary Note 18

The display system according to Supplementary Note 16 or 17, in which
the accepting means accepts an operation on the touch panel as an operation on a user reflected in the mirror.

### Supplementary Note 19

The display system according to Supplementary Note 14 or 15, further including a second display, in which
the second display is arranged on a surface opposite to the aerial image formation with respect to the optical element in such a way that display of the second display and the aerial image formation are superimposed.

### Supplementary Note 20

The display system according to Supplementary Note 14 or 15, further including an object, in which
the object is arranged on a surface opposite to the aerial image formation with respect to the optical element in such a way that the object and the aerial image formation are superimposed.

### Supplementary Note 21

The display system according to Supplementary Note 20, further including an imaging device that captures an image of the object, in which
the control device includes:
a detection means for detecting the object from an image captured by the imaging device,
the processing means decides a display content on the display based on the detected object, and
the output control means displays the decided display content on the display.

### Supplementary Note 22

A control device including:
an accepting means for accepting an operation on aerial image formation detected by a sensor included in a non-contact display installed in a vehicle and an operation on a touch panel overlaid on a part of a surface of an optical element included in the non-contact display;
a processing means for performing processing according to an operation on the aerial image formation in a case where the operation on the aerial image formation is accepted, and performing processing according to an operation on the touch panel in a case where the operation on the touch panel is accepted; and
an output control means for controlling display on a display included in the non-contact display based on a processing result by the processing means, in which
an operation on the aerial image formation is an operation by a passenger on a passenger seat in the vehicle,
an operation on the touch panel is an operation by a driver of the vehicle, and
the accepting means accepts an operation on the aerial image formation and does not accept an operation on the touch panel while the vehicle is traveling.

### Supplementary Note 23

A control method including:
accepting, as different operations, an operation on aerial image formation detected by a sensor included in a non-contact display and an operation on a touch panel overlaid on a part of a surface of an optical element included in the non-contact display;
performing processing according to an operation on the aerial image formation in a case where the operation on the aerial image formation is accepted, and performing processing according to an operation on the touch panel in a case where the operation on the touch panel is accepted; and
controlling display on a display included in the non-contact display based on a processing result.

### Supplementary Note 24

A control method including:
accepting an operation on aerial image formation detected by a sensor included in a non-contact display installed in a vehicle and an operation on a touch panel overlaid on a part of a surface of an optical element included in the non-contact display;
performing processing according to an operation on the aerial image formation in a case where the operation on the aerial image formation is accepted, and performing processing according to an operation on the touch panel in a case where the operation on the touch panel is accepted; and
controlling display on a display included in the non-contact display based on a processing result by the processing means, in which
an operation on the aerial image formation is an operation by a passenger on a passenger seat in the vehicle,
an operation on the touch panel is an operation by a driver of the vehicle, and
in the accepting, an operation on the aerial image formation is accepted and an operation on the touch panel is not accepted while the vehicle is traveling.

### Supplementary Note 25

A non-transitory computer-readable recording medium having recorded therein a program for causing a computer to execute:
accepting, as different operations, an operation on aerial image formation detected by a sensor included in a non-contact display and an operation on a touch panel overlaid on a part of a surface of an optical element included in the non-contact display;
performing processing according to an operation on the aerial image formation in a case where the operation on the aerial image formation is accepted, and performing processing according to an operation on the touch panel in a case where the operation on the touch panel is accepted; and
controlling display on a display included in the non-contact display based on a processing result.

### Supplementary Note 26

A non-transitory computer-readable recording medium having recorded therein a program causing a computer to execute:
accepting an operation on aerial image formation detected by a sensor included in a non-contact display installed in a vehicle and an operation on a touch panel overlaid on a part of a surface of an optical element included in the non-contact display;
performing processing according to an operation on the aerial image formation in a case where the operation on the aerial image formation is accepted, and performing processing according to an operation on the touch panel in a case where the operation on the touch panel is accepted; and
controlling display on a display included in the non-contact display based on a processing result, in which
an operation on the aerial image formation is an operation by a passenger on a passenger seat in the vehicle,
an operation on the touch panel is an operation by a driver of the vehicle, and
in the accepting, an operation on the aerial image formation is accepted and an operation on the touch panel is not accepted while the vehicle is traveling.

### Supplementary Note 27

A program for causing a computer to execute:
accepting, as different operations, an operation on aerial image formation detected by a sensor included in a non-contact display and an operation on a touch panel overlaid on a part of a surface of an optical element included in the non-contact display;
performing processing according to an operation on the aerial image formation in a case where the operation on the aerial image formation is accepted, and performing processing according to an operation on the touch panel in a case where the operation on the touch panel is accepted; and
controlling display on a display included in the non-contact display based on a processing result.

### Supplementary Note 28

A program causing a computer to execute:
accepting an operation on aerial image formation detected by a sensor included in a non-contact display installed in a vehicle and an operation on a touch panel overlaid on a part of a surface of an optical element included in the non-contact display;
performing processing according to an operation on the aerial image formation in a case where the operation on the aerial image formation is accepted, and performing processing according to an operation on the touch panel in a case where the operation on the touch panel is accepted; and
controlling display on a display included in the non-contact display based on a processing result, in which
an operation on the aerial image formation is an operation by a passenger on a passenger seat in the vehicle,
an operation on the touch panel is an operation by a driver of the vehicle, and
in the accepting, an operation on the aerial image formation is accepted and an operation on the touch panel is not accepted while the vehicle is traveling.

### REFERENCE SIGNS LIST

1 display system
10 aerial display
11, 21 control device
31 imaging device
32 reading device
33 reading device
34 mirror
35 second display
36 object
37 imaging device
38 imaging device
39 imaging device
80 computer
101 optical element
102 display
103 touch panel
104 aerial image formation
105 sensor
111, 211 accepting unit
112, 212 processing unit
113, 213 output control unit
114 correction unit
115 determination unit
116 detection unit
801 processor
802 ROM
803 RAM
804 storage device
805 communication interface
806 input/output interface
807 bus
NT communication network

1. A control device comprising:
at least one memory storing instructions; and
at least one processor configured to execute the instructions to:
accept, as different operations, an operation on aerial image formation detected by a sensor included in a non-contact display and an operation on a touch panel overlaid on a part of a surface of an optical element included in the non-contact display;
perform processing according to an operation on the aerial image formation in a case where the operation on the aerial image formation is accepted, and performing processing according to an operation on the touch panel in a case where the operation on the touch panel is accepted; and
control display on a display included in the non-contact display based on a processing result.

2. The control device according to claim 1, wherein
an operation on the aerial image formation is an operation by a first user, and
an operation on the touch panel is an operation by a second user.

3. The control device according to claim 2, wherein the at least one processor is further configured to execute the instructions to:
detect a position of a face of the second user from an image in which the second user is captured by an imaging device; and
correct a position of an accepted operation on the touch panel based on the position of the face of the second user.

4. The control device according to claim 2, wherein
in a case where the non-contact display is installed in a vehicle,
the first user is a passenger in a passenger seat in the vehicle,
the second user is a driver of the vehicle, and the at least one processor is further configured to execute the instructions to:
accept an operation on the aerial image formation and does not accept an operation on the touch panel while the vehicle is traveling.

5. The control device according to claim 2, wherein
in a case where the non-contact display is installed in a store,
the first user is a customer, and
the second user is a clerk.

6. The control device according to claim 1, wherein the at least one processor is further configured to execute the instructions to:
output different voices at a time of operation on the aerial image formation and at a time of operation on the touch panel.

7. The control device according to claim 1, wherein the at least one processor is further configured to execute the instructions to:
output different vibrations at a time of operation on the aerial image formation and at a time of operation on the touch panel.

8. The control device according to claim 1, wherein an operation on the aerial image formation is an operation relevant to a designated position of the aerial image formation, and
an operation on the touch panel is at least one of an operation of instructing display of a menu for performing an operation related to a position where an operation on the touch panel has been performed, an operation of instructing display of a menu for performing a setting related to the position where an operation on the touch panel has been performed, and an operation of instructing display of information related to the position where an operation on the touch panel has been performed.

9. The control device according claim 1, wherein
in a case where the non-contact display is installed in a store,
an operation on the touch panel is an operation related to payment among operations related to product registration and settlement in the store, and
an operation on the aerial image formation is an operation other than an operation related to the payment among operations related to the product registration and the settlement.

10. The control device according to claim 1, comprising wherein the at least one processor is further configured to execute the instructions to:
determine, based on a position of a hand of a user performing an operation on the aerial image formation, whether the hand of the user is present on an optical element side beyond the aerial image formation, and
accept an operation on the aerial image formation in a case where the hand is not on the optical element side, and not accept an operation on the aerial image formation in a case where the hand is on the optical element side.

11. The control device according to claim 10, wherein the at least one processor is further configured to execute the instructions to:
determine whether the hand of the user is present on the optical element side beyond the aerial image formation based on the position of the hand of the user detected by the sensor.

12. The control device according to claim 10, wherein the at least one processor is further configured to execute the instructions to:
detect the hand of the user from an image in which the hand of the user performing an operation on the aerial image formation is captured by an imaging device; and
determine whether the hand of the user is present on the optical element side beyond the aerial image formation based on the position of the detected hand of the user.

13. The control device according to claim 1, wherein the at least one processor is further configured to execute the instructions to:
detect a position of a face of a user who performs an operation on the aerial image formation from an image in which the user is captured by an imaging device; and
correct a position of an accepted operation on the aerial image formation based on the detected position of the face of the user.

14. A display system comprising:
a non-contact display; and
a control device, wherein
the non-contact display includes:
a touch panel;
an optical element;
a display; and
a sensor,
the touch panel is arranged by being overlaid on a part of a surface of the optical element,
the touch panel detects an operation on a touch panel thereof,
the sensor detects an operation on the display and aerial image formation formed by the optical element, and
the control device includes: at least one memory storing instructions; and
at least one processor configured to execute the instructions to:
accept, as different operations, an operation on the aerial image formation and an operation on the touch panel;
perform processing according to an operation on the aerial image formation in a case where the operation on the aerial image formation is accepted, and performing processing according to an operation on the touch panel in a case where the operation on the touch panel is accepted; and
control display on the display based on a processing result.

15. The display system according to claim 14, wherein the at least one processor is further configured to execute the instructions to:
determine, based on a position of a hand of a user performing an operation on the aerial image formation, whether the hand of the user is present on the optical element side beyond the aerial image formation; and
accept an operation on the aerial image formation in a case where the hand is not on the optical element side, and not accept an operation on the aerial image formation in a case where the hand is on the optical element side.

16. The display system according to claim 14, further comprising a mirror, wherein
the mirror is arranged on a surface opposite to the aerial image formation with respect to the optical element in such a way that an image reflected in the mirror and the aerial image formation are superimposed.

17. The display system according to claim 16, further comprising an imaging device, wherein
the imaging device captures an image of a user who performs an operation on the aerial image formation,
the at least one processor is further configured to execute the instructions to:
detect a movement of the user from the image captured by the imaging device; and
control display of the display based on the movement of the user.

18. The display system according to claim 16, wherein the at least one processor is further configured to execute the instructions to:
accept an operation on the touch panel as an operation on a user reflected in the mirror.

19. The display system according to claim 14, further comprising a second display, wherein
the second display is arranged on a surface opposite to the aerial image formation with respect to the optical element in such a way that display of the second display and the aerial image formation are superimposed.

20.-22. (canceled)

23. A control method comprising:
accepting, as different operations, an operation on aerial image formation detected by a sensor included in a non-contact display and an operation on a touch panel overlaid on a part of a surface of an optical element included in the non-contact display;
performing processing according to an operation on the aerial image formation in a case where the operation on the aerial image formation is accepted, and performing processing according to an operation on the touch panel in a case where the operation on the touch panel is accepted; and
controlling display on a display included in the non-contact display based on a processing result.

24.-26. (canceled)
